(19) United States
(12) Patent Application Publication
(10) Pub. No.: US 2009/0015133 A1
(43) Pub. Date: Jan. 15, 2009

(54) FIELD EMISSION DEVICE AND ELECTRODE STRUCTURE THEREOF

(75) Inventors: Woo-Hu TSAI, Taipei (TW); Tzung-Han Yang, Taipei (TW); Hsin-Ju Wu, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: Tatung Company, Taipei (TW)

(21) Appl. No.: 12/061,818

(22) Filed: Apr. 3, 2008

(30) Foreign Application Priority Data
Jul. 12, 2007 (TW) 096125373

(51) Int. Cl. H01J 1/62

(52) U.S. Cl. 313/498; 313/326

(57) ABSTRACT

The present invention relates to a field emission device and an electrode structure thereof, comprising a starting base and a curved extending part formed on a surface of various shaped or dimensional structure. Therefore, the applied device and range is increased. The curved extending part is also for reducing the number of the contact point, as to simplify the procedure to design the peripheral circuit. Besides, a resisting section can be formed on the starting base. The resisting value of the resisting section is designed to provide various lighting effects.

### RELATED APPLICATIONS

The present application is based on, and claims priority from, Taiwan Application Number 096125373, filed Jul. 12, 2007, the disclosure of which is hereby incorporated by reference herein in its entirety.

### BACKGROUND OF THE INVENTION

1. Field of the Invention

The present invention relates to a field emission device and an electrode structure thereof and, more particularly, to a field emission device and an electrode structure thereof suitable for displaying or illuminating.

2. Description of Related Art

In current light-emitting devices, a field emission device is favored due to its stable structure and uniform luminance. The field emission device can apply to various electric structures, such as a lamp, a display device, or a back light module.

The luminance mechanism of the field emission device is that an electric potential is applied to the gate electrode to draw electrons out of the cathode, and the electrons are attracted and accelerated by the electric potential at the anode to bombard the fluorescence material coated on the anode so that the fluorescence material, absorbing partial energy of the electrons, is excited to generate light.

Conventionally, cathodes of a field emission device are formed into the shape of plural separated bars consisting of an electron source material on a cathode base, and gate electrodes consisting of a conductive material is formed into the shape of plural bars at the periphery of the cathodes. Therefore, a driving circuit can transmit different driving signals to each cathode and gate electrode individually for controlling their electric potentials, such that the cathodes can emit electrons and a fluorescence material can generates light. Unfortunately, since the electron sources or the gate electrodes are plural and separated the number of electric contacts is increased so as to complicate the driving circuit. This problem is a large obstacle to the manufacturing of a field emission device.

### SUMMARY OF THE INVENTION

The object of the present invention is to provide an electrode structure of a field emission device for decreasing electric contacts so that the circuit design can be simplified.

Another object of the present invention is to provide an electrode structure of a field emission device suitable for being applied to various shapes of surfaces or stereo-structures.

The other object of the present invention is to provide an electrode structure of a field emission device for improving the illumination uniformity of the field emission device.

To achieve the objects, an electrode structure of a field emission device of the present invention includes a starting base and at least one extending part. The extending part connects to the starting base, and the extending part is winding-shaped.

To achieve the objects, a field emission device of the present invention includes an anode and a cathode. The cathode is disposed corresponding to the anode. The cathode comprises a starting base and at least one extending part, wherein the extending part connecting to the starting base is winding-shaped.

When electric potentials of reverse parity are individually applied to the anode and the cathode of the field emission device, electrons emitted from the cathode to the anode. However, the field emission device comprising a fluorescence material is preferred because the fluorescence material illuminates light as the electrons bombard the fluorescence material. Moreover, the field emission device can further comprises a gate electrode disposed at the periphery of the cathode. The electric potential applied to the gate electrode controls whether the electrons emit from the cathode or not. Also, the gate electrode can comprises a starting base and an extending part, wherein the extending part connecting to the starting base is winding-shaped.

The electrode structure can be an electron source or a gate electrode. In addition, the electrode structure can be formed on various shapes of a surface or a surface of a stereo-structure, such as a plane surface in the shape of a circle, an ellipse or a polygon, or a surface of a stereo-structure in the shape of a sphere, a hemisphere or a cylinder. Hence, the winding-shaped extending part can reduce the number of the electric contacts so as to simplify the design of the peripheral circuit.

The electrode structure can be made of any conventional material. Preferably, the electrode structure is made of an electron source material or a conductive material. The electron source material can be any material with low work function, such as silicon, metal or carbonic material. Preferably, the electron source material is polysilicon, molybdenum, niobium, wolfram, diamond film, carbon nanotube or graphite. The conductive material can be metal, such as silver or gold.

The shape of the starting base is not limited. Preferably, the starting base is in the shape of a bar. The shape of the extending part is not limited. Preferably, the extending part is in the shape of an arc, a circle or a spiral, such as circular spiral or polygon spiral. The number of the extending parts is not limited. Preferably, the number of the extending parts is more than one.

As the electrode structure is functioning as a cathode, the electrode structure emits electrons under an electric field. As the electrode structure is functioning as a gate electrode, a positive potential is applied to its starting base. In addition, the starting base of the gate electrode can further comprises a resistance disposed between two extending parts of the gate electrode. Preferably, the resistance is made of a material with low resistance value. Therefore, the decrease of the electric potential caused by the increase of the transmitting path at two extending parts can be compensated, and the illumination uniformity of the field emission device is improved.

The field emission device of the present invention comprising at least one winding-shaped extending part or plural extending parts connected to each other can be formed on a plan surface, a curved surface or a surface of a stereo-structure. Accordingly, the number of the electric contacts is reduced so as to simplify the design of the circuit. In addition, each part of the electrode structure can further comprises a resistance with different resistance value for compensating the decrease of the electric potentials at each part of the electrode structure so that the illumination uniformity of the field emission device can be improved.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a schematic drawing of the field emission device according to a preferred embodiment of the present invention;

FIG. 2 is a schematic drawing of the cathode of the field emission device according to a preferred embodiment of the present invention;

FIG. 3 is a schematic drawing the cathode according to another preferred embodiment of the present invention;

FIG. 4 is a schematic drawing the cathode according to the other preferred embodiment of the present invention;

FIG. 5 is a schematic drawing the cathode according to the other preferred embodiment of the present invention; and

FIG. 6 is a schematic drawing the cathode according to the other preferred embodiment of the present invention.

### DETAILED DESCRIPTION OF THE PREFERRED EMBODIMENT

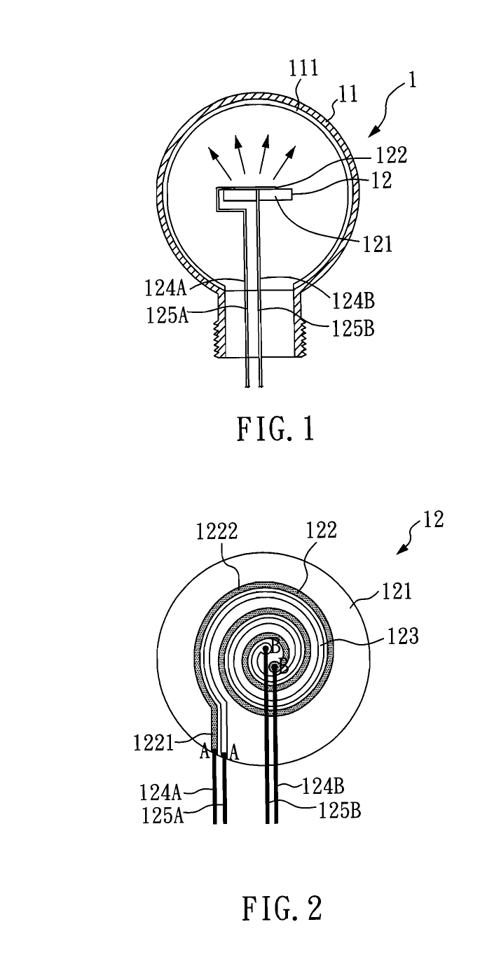

With reference to FIG. 1 and FIG. 2, FIG. 1 shows a schematic drawing of a field emission device according to the first preferred embodiment of the present invention, and FIG. 2 shows a schematic drawing of the cathode of this embodiment. As shown in FIG. 1 and FIG. 2, field emission device 1 comprises an anode 11 and a cathode 12 corresponding to the anode 11. In this embodiment, the anode 11 made of a transparent conducting-material, indium-tin oxide (ITO), is applied with a positive potential. A fluorescence material radiating visible light is coated on the anode 11. Moreover, the space between the anode 11 and the cathode 12 is at a low-pressure environment near a vacuum such that the pollution of and the damage to the anode 11 and the cathode 12 caused by impurities can be prevented. In this embodiment, the pressure of the space is maintained below 10⁻⁶ torr.

The cathode 12 comprises a substrate 121, an electron source 122 and a gate electrode 123, wherein the electron source 122 and the gate electrode 123 is formed on the substrate 121, and the electron source 122 is located corresponding to the anode 11. In this embodiment, the substrate 121 is a glass substrate. The electron source 122 is made of an electron source material. Precisely, the electron source 122 of this embodiment is made of carbon nanotube (CNT). In addition, the gate electrode 123 made of conducting-material is disposed at the periphery of the electron source 122. In this embodiment, the gate electrode 123 is formed by screen-printing metal slurry on a surface of the substrate 121.

The electron source 122 comprises a starting base 1221 and an extending part 1222 connecting to the starting base 1221. In this embodiment, the starting base 1221 of the electron source 122 is in the shape of a bar. Most importantly, the extending part 1222 is winding-shaped. In this embodiment, the extending part 1222 is in the shape of a circular spiral. Also, the shape of the gate electrode 123 is a combination of a bar and a circular spiral. The extremities of the electron source 122 and the gate electrode 123, i.e. the electric contact A of the starting base 1221 of the electron source 122, the electric contact B of the extending part 1222 of the electron source 122, the electric contact A of the gate electrode 123 and the electric contact B of the gate electrode 123, electrically connects to a driving circuit (not shown) through circuit 124A, 124B, 125A and 125B. Hence, the driving circuit, connecting to the electric contacts A and B through the circuit 124A, 124B, 125A and 125B that passing through the cathode 12, can control the electric potential of the electron source 122 and the gate electrode 123. As the electric potential of the anode 11 is positive and the electric potential of the electron source 122 is zero, negative, or below the electric potential of the anode 11, the potential deference between the anode 11 and the electron source 122 is large enough for the electron source 122 to emit electrons toward the anode 11, such that the fluorescence material 111 illuminates light. On the other hand, the electron source 122 emits no electrons as the electric potential of the electron source 122 is high and the potential deference between the anode 11 and the electron source 122 is not large enough for the electron source 122 to emit electrons, such that fluorescence material 111 illuminates no light. In addition, the gate electrode 123 is used to reduce the electric potential of the gate electrode 123 for improving illumination uniformity. In this embodiment, the effect of controlling luminance as mentioned above can be achieved when the electron source 122, as well as gate electrode 123, connects to the driving circuit through two electric contacts A and B. Therefore, the design of the driving circuit can be simplified.

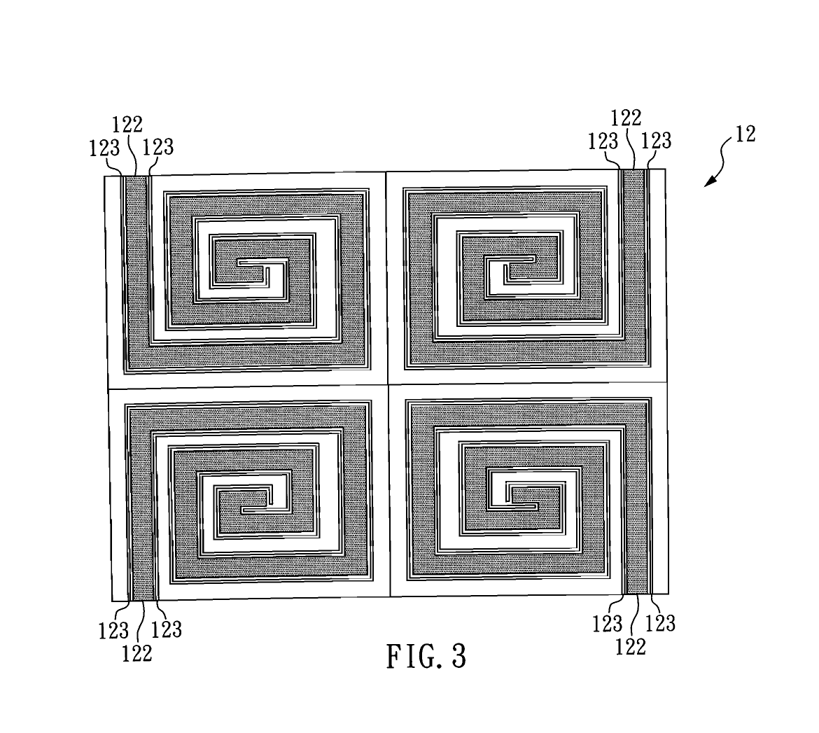

FIG. 3 shows the schematic drawing of the cathode according to the second preferred embodiment of the present invention. As shown in FIG. 3, it can tell several differences between the cathode of this embodiment and the first preferred embodiment. Firstly, in this embodiment, each of the extending part 1222 of the electron source 122, formed on the square cathode 12, is in the shape of a quadrilateral spiral. The extending parts 1222's number is four and they are arranged in a matrix. Secondly, at least one gate electrode 123 is formed at two sides of the periphery of the electron source 122 for increasing the electric field. Thirdly, the driving circuit (not shown) electrically connecting to the electron source 122 and the gate electrode 123 controls four electron sources 122 to emit electrons at different time alternately or at the same time so that various illumination effect can be achieved.

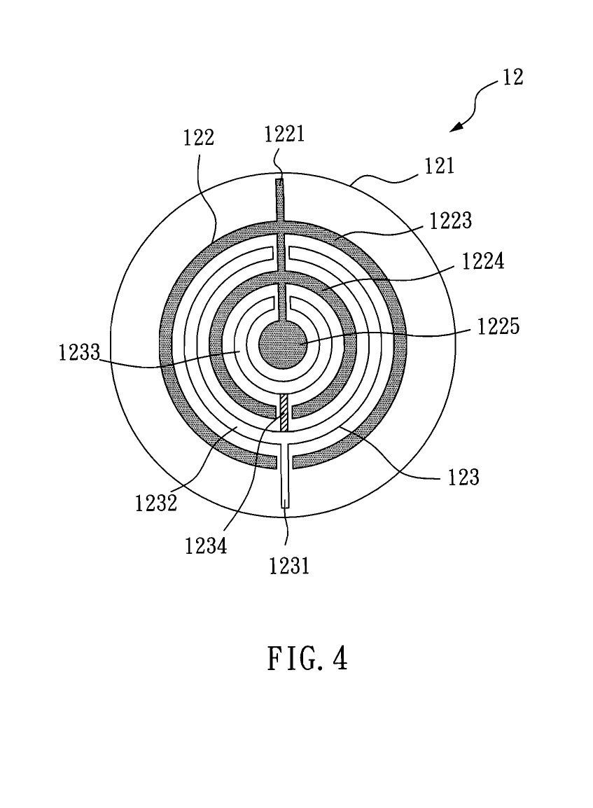

FIG. 4 shows the schematic drawing of the cathode 12 according to the third preferred embodiment of the present invention. In this embodiment, the cathode 12 comprises a substrate 121, an electron source 122 and a gate electrode 123. As shown in FIG. 4, it can tell several differences between the cathode of this embodiment and the first preferred embodiment. Firstly, there are plural extending parts 1223, 1224 and 1225 connects to the starting base 1221 of the electron source 122, and the shapes of these extending parts 1223, 1224 and 1225 are arcs or circles. Secondly, the gate electrode 123 comprises a starting base 1231 and plural extending parts 1232 and 1233, and the shapes of these extending parts 1232 and 1233 are arcs. Thirdly, a resistance 1234 is formed between the extending parts 1232 and 1233 of the gate electrode 123. The resistance 1234 is made of a material with low resistance value. In this embodiment, the resistance 1234 is manufactured using ruthenium oxide by screen-printing. Also, the resistance 1234, as shown in FIG. 4, can be manufactured using other resistance material by other method, such as inkjet-printing, vapor deposition, or sputtering. Accordingly, the decrease of the electric potential caused by the increase of the transmitting path of circuits can be compensated so that the electric potentials of the extending part 1232 and the extending part 1233 are getting closer. Therefore, the electric field applied to the extending parts 1223, 1224 and 1225 of the electron source 122 is similar, and the illumination uniformity of the field emission device is improved. Moreover, the resistance value of the resistance 1234 can be modified depending on the desired illumination effect. For instance, the modification of the resistance value of the resistance 1234 can cause the extending part 1232 and the extending part 1233 of the electron source 122 to have different electric potentials. Hence, this electron source 122 is suitable to be used in a field emission device with gradient illuminating-light.

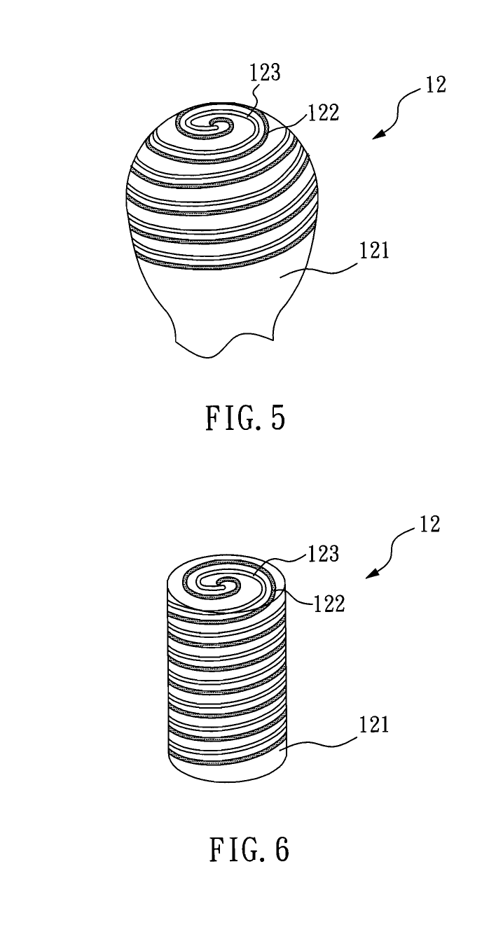

FIG. 5 shows the schematic drawing of the field emission device according to the fourth preferred embodiment of the present invention. As shown in FIG. 5, the difference between this embodiment and the first preferred embodiment is that the electron source 122 and the gate electrode 123 are formed on the surface of a sphere. In other words, the substrate 121 of the cathode 12 is a sphere. FIG. 6 shows the schematic drawing of the field emission device according to the fifth preferred embodiment of the present invention.

As shown in FIG. 6, the difference between this embodiment and the fifth preferred embodiment is that the electron source 122 and the gate electrode 123 are formed on the surface of a sphere. In other words, the substrate 121 of the cathode 12 is a cylinder substrate 121. Accordingly, the electrode structure of the present invention can be formed on various shapes of surface and stereo-structure.

To sum up, the field emission device, as well as the electrode structure thereof, of the present invention comprises a starting base and a winding-shaped extending part. Therefore, the electrode structure can be formed on various shapes of surface and stereo-structure so that its application scope is increased. In addition, the winding-shaped extending part can decrease the number of electric contacts. Accordingly, the design of the peripheral circuit can be simplified and put into practice easily. Moreover, the starting base can further comprise a resistance. Through the modification of the resistance value, different illumination effect can be achieved.

Although the present invention has been explained in relation to its preferred embodiment, it is to be understood that many other possible modifications and variations can be made without departing from the scope of the invention as hereinafter claimed.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

What is claimed is:

1. An electrode structure of a field emission device, comprising:
a starting base; and
at least one extending part connecting to the starting base
wherein the extending part is winding-shaped.

2. The electrode structure as claimed in claim 1, wherein the starting base is in the shape of a bar.

3. The electrode structure as claimed in claim 1, wherein the extending part is in the shape of an arc, a circle or a spiral.

4. The electrode structure as claimed in claim 1, wherein the number of the extending parts is more than one.

5. The electrode structure as claimed in claim 1, wherein the starting base further comprises a resistance disposed between the extending parts.

6. The electrode structure as claimed in claim 1, wherein the electrode structure is formed on a surface.

7. The electrode structure as claimed in claim 6, wherein the surface is a plane surface, a curved surface or a surface of a sphere, a hemisphere or a cylinder.

8. The electrode structure as claimed in claim 1, wherein the electrode structure comprises at least one electron source or at least one gate electrode.

9. A field emission device, comprising:
an anode; and
a cathode disposed corresponding to the anode, wherein the cathode comprises a starting base and at least one extending part connecting to the starting base, and the extending part is winding-shaped.

10. The field emission device as claimed in claim 9, further comprising a gate electrode disposed at the periphery of the cathode.

11. The field emission device as claimed in claim 10, wherein the gate electrode comprises a starting base and at least one extending part connecting to the starting base, and the extending part of the gate electrode is winding-shaped.

12. The field emission device as claimed in claim 11, wherein the starting base of the gate electrode is in the shape of a bar.

13. The field emission device as claimed in claim 11, wherein the extending part of the gate electrode is in the shape of an arc, a circle or a spiral.

14. The field emission device as claimed in claim 11, wherein the number of the extending parts of the gate electrode is more than one.

15. The field emission device as claimed in claim 11, wherein the starting base of the gate electrode further comprises a resistance disposed between the extending parts.

16. The field emission device as claimed in claim 11, wherein the starting base of the cathode is in the shape of a bar.

17. The field emission device as claimed in claim 11, wherein the extending part of the cathode is in the shape of an arc, a circle or a spiral.

18. The field emission device as claimed in claim 11, wherein the number of the extending part of the cathode is more than one.

19. The field emission device as claimed in claim 9, further comprising a substrate, and the cathode is disposed on a surface of the substrate.

20. The field emission device as claimed in claim 19, wherein the surface of the substrate is a plane surface, a curved surface or a surface of a sphere, a hemisphere or a cylinder.

21. The field emission device as claimed in claim 9, wherein the anode further comprises a fluorescence material.
